(19) United States
(12) Patent Application Publication
(10) Pub. No.: US 2009/0166281 A1
(43) Pub. Date: Jul. 2, 2009

(54) FLOATING DEVICE TO PREVENT CONTAMINATION OF A LIQUID OR PASTY MEDIUM PLACED IN A CONTAINER

(76) Inventor: Oscar Anselmo ANTONETTI, Prov. De Buenos Aires (AR)

Correspondence Address: YOUNG & THOMPSON, 209 Madison Street, Suite 500, ALEXANDRIA, VA, 22314, US

(21) Appl. No.: 12/199,864

(22) Filed: Aug. 28, 2008

(30) Foreign Application Priority Data
Dec. 28, 2007 (AR) P20070105963

(51) Int. Cl. B01D 33/00

(52) U.S. Cl. 210/242.1

(57) ABSTRACT

A floating device (3) to prevent contamination of a liquid or pasty medium (2) placed inside a container (1), the floating device (3) having an area substantially identical to the cross section of the container (1), and being constituted by a material having less density than the density of the liquid or pasty medium (2) contained inside the container (1), thus allowing the floating device (3) to float upon said liquid or pasty medium (2).

The present invention relates to a floating device for preventing contamination of a liquid or pasty medium placed in a container.

Even the purest liquid becomes contaminated when in contact with air. In water cans with only one opening placed upside down, the out-flowing liquid allows the inflow of bubbling air with dispersed particles that attach to the liquid still remaining in the container. In other words, the air cleans and the liquid soils.

It has been determined that in transited areas the amount of static particles per cubic foot is of 4000000 to 5000000, and no less than 150000 if filters are used.

Thus, in order to overcome all these inconveniences, this invention combines the following features: a floating device placed inside a container, constituted by a material less dense than a liquid or pasty medium placed inside such container, in a way that such floating device is interposed between such liquid or pasty medium and the surrounding environment, which is capable of contaminating such liquid or pasty medium. Likewise, and in order to achieve this objective, said floating device must be inalterable to the action of the liquid or pasty medium and ultraviolet rays. In addition, the area of such floating device must be substantially identical to the cross section of the container wherein it is placed.

Therefore, an object of the present invention is a floating device for preventing contamination of a liquid or pasty medium placed inside a container, where the area of such floating device is substantially identical to the cross section of the container, and where the floating device is constituted of a material less dense than the contained liquid or pasty medium, thus allowing the floating devise to float on such liquid or pasty medium.

A brief reference to the Figures of the invention follows.

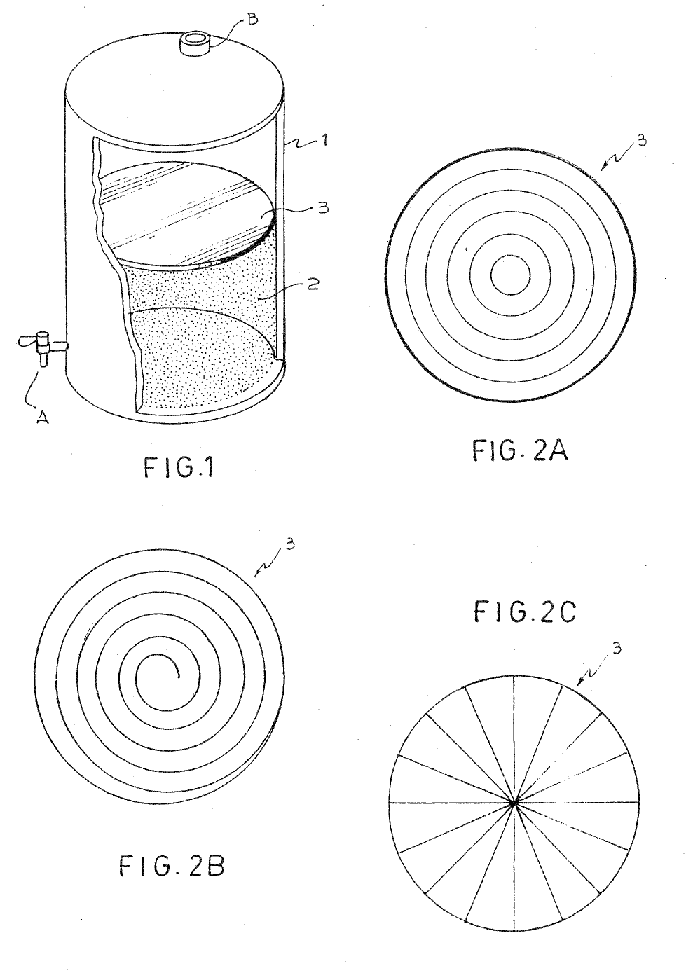

FIG. 1 shows a cross cut of a container wherein the floating device of the invention is seen floating.

FIGS. 2A, 2B, and 2C illustrate different settings, which may be adopted by said floating device.

More specifically, said FIG. 1 illustrates a container 1, which in the present preferred embodiment is of cylindrical cross section, containing a liquid or pasty medium 2 upon which a floating device 3 floats.

Said floating device 3 has an area substantially identical to the cross section of said container 1, and is constituted by a material having a lower density than the density of said liquid or pasty medium 2, allowing said floating device 3 to float upon such liquid or pasty medium.

Said floating device 2 may include air chambers arranged in annular (see FIG. 2A), spiral (see FIG. 2B), or radial (see FIG. 2C) form in order to provide flexibility when inserting the floating device 3 in such container 1, and expansion of said floating device 3 to cover substantially all the cross section of such container 1. In addition, such floating device 3 must be impermeable and inalterable to the action of the liquid or pasty medium 2 and ultraviolet rays. Said floating device 3 is produced from a flexible plastic material allowing it being inserted and later expanded inside the container 1, for example poly propylene, or the like.

Said floating device 3 may be placed inside a container 1 including at least two openings A,B, one of which, A, is used to pour such liquid or pasty medium 2, while the other, B, is placed opposite to the former, A, and is used for air entering said container 1.

Said floating device 3 may also be placed inside a container 1 including a single opening. In this case, the floating device 3 must be tilted for air entering through half of the cross section of said single opening. Later, when it is leveled, said floating device 3 again covers completely said liquid or pasty medium 2.

1. A floating device (3) preventing contamination of a liquid or pasty medium (2) placed inside a container (1), said floating device (3) characterized by having a cross section substantially identical to the cross section of said container (1), and by said floating device (3) being constituted by a material having less density than the density of the liquid or pasty medium (2) contained in it, allowing said floating device (3) to float upon said liquid or pasty medium (2).

2. The devise of claim 1, characterized by said floating device (3) including air chambers placed in annular, spiral, or radial form, in order to provide flexibility in inserting it inside said container (1), and expansion to cover substantially all the cross section of said container (1).

3. The device of claim 1, characterized by said floating device (3) additionally being impermeable and inalterable to the action of the liquid or pasty medium (2) and ultraviolet rays.

4. The device of claim 1, characterized by said floating device (3) being produced from a flexible plastic material allowing it being inserted and then expanded inside said container (1).

5. The device of claim 4, characterized in that said material is poly propylene, or the like.

6. The device of claim 1, characterized by said floating device (3) being placed inside a container (1) including at least two openings (A,B), one of which (A) is used to pour said liquid or pasty medium (2), while the other (B) is placed opposite to the former, and is used for air entering said container (1).

7. The device of claim 1, characterized by said floating device (3) being placed inside a container (1) which includes a single opening, and therefore said floating device (3) must be tilted in order to allow air entering through half the cross section of said single opening; and later, when leveled, said floating device (3) again covers completely said liquid or pasty medium (2).
